(19) United States
(12) Patent Application Publication
(10) Pub. No.: US 2026/0187773 A1
(43) Pub. Date: Jul. 2, 2026

(54) MACHINE LEARNING-BASED DISPLAY UNIFORMITY COMPENSATION METHOD, STORAGE MEDIUM AND TERMINAL

(71) Applicant: Shanghai Tianma Micro-electronics Co., Ltd., Shanghai (CN)

(72) Inventors: Bojia LYU, Shanghai (CN); Yanjun ZHANG, Shanghai (CN)

(21) Appl. No.: 19/089,561

(22) Filed: Mar. 25, 2025

(30) Foreign Application Priority Data
Dec. 31, 2024 (CN) 202411999809.X

(51) Int. Cl. G06T 7/00; G09G 3/20; G09G 3/32

(52) U.S. Cl. CPC G06T 7/0002; G09G 3/2007; G06T 2207/10024; G06T 2207/20081; G06T 2207/20084; G06T 2207/30168; G09G 3/32; G09G 2320/0233

(57) ABSTRACT

A machine learning-based display uniformity compensation method, storage medium and terminal, where the method includes providing a plurality of target grayscale data, obtaining a plurality of captured images, obtaining compensated result grayscale data of each captured image, providing a machine learning model, completing the training and testing of the machine learning model based on the target grayscale data and the compensated result grayscale data, solidifying the model architecture and model parameters of the machine learning model to a to-be-compensated display device, and outputting the applied grayscale data of the to-be-compensated display device based on the machine learning model.

### CROSS-REFERENCE TO RELATED DISCLOSURE

The present disclosure claims priority of Chinese Patent Disclosure No. 202411999809.X, filed on Dec. 31, 2024, the entire content of which is hereby incorporated by reference.

### FIELD OF THE DISCLOSURE

The present disclosure relates to the field of display technology, and in particular to a machine learning-based display uniformity compensation method, storage medium and terminal.

### BACKGROUND

Display uniformity compensation technology is a digital processing technology that improves the uneven optical properties of flat panel display products. It adjusts the brightness of sub-pixels by controlling grayscale data, so that pixels with large brightness or chromaticity deviations may work according to the expected optical goals.

Demura technology used in Active Matrix Organic Light Emitting Diode (AMOLED) products is a practical application of display uniformity compensation technology. It performs fitting calculations by analyzing the relationship between sub-pixel brightness and grayscale, and then calculates the compensation amount for each pixel. The compensation data is stored in the flash of the display module, and an input display image is compensated by calling the compensation data in real-time through the driver IC.

Micro Light Emitting Diode Display (MicroLED) as a new display technology also requires display uniformity compensation technology for optical improvement. Due to the properties of the process and materials, the industry generally believes that MicroLED needs to compensate for uniformity of brightness and color at the same time.

However, there are still many problems with the existing technologies when MicroLED is used to compensate for display uniformity.

### SUMMARY

The technical solution provided by the disclosure is to provide a machine learning-based display uniformity compensation method, storage medium and terminal, so as to improve the display uniformity compensation effect and efficiency, and reduce the cost of data storage and driving operation.

In order to solve the above problems, the disclosure provides a machine learning-based display uniformity compensation method, including: providing a plurality of target grayscale data; acquiring a plurality of corresponding captured images based on the plurality of target grayscale data, where the captured images are divided into a training set and a test set; obtaining compensated result grayscale data of each captured image based on data calculation; providing a machine learning model; inputting target grayscale data and compensated result grayscale data of each captured image in the training set into the machine learning model for model training; after model training, inputting target grayscale data of each captured image in the test set into the trained machine learning model for model testing, and outputting corresponding predicted grayscale data based on the machine learning model; comparing each predicted grayscale data with compensated result grayscale data of a corresponding captured image in the test set until a test accuracy reaches a preset accuracy, thereby completing a model test of the machine learning model; solidifying a model architecture of the machine learning model that has passed the test to a to-be-compensated display device; writing model parameters of the machine learning model that has passed the test into the to-be-compensated display device; and processing to-be-compensated target grayscale data input into the to-be-compensated display device by using the machine learning model, and outputting applied grayscale data of the to-be-compensated display device based on the machine learning model.

Correspondingly, embodiments of the disclosure further provide a non-transitory computer-readable storage medium, storing a computer program that, when being executed, causes at least one processor to implement: providing a plurality of target grayscale data; acquiring a plurality of corresponding captured images based on the plurality of target grayscale data, where the captured images are divided into a training set and a test set; obtaining compensated result grayscale data of each captured image based on data calculation; providing a machine learning model; inputting target grayscale data and compensated result grayscale data of each captured image in the training set into the machine learning model for model training; after model training, inputting target grayscale data of each captured image in the test set into the trained machine learning model for model testing, and outputting corresponding predicted grayscale data based on the machine learning model; comparing each predicted grayscale data with compensated result grayscale data of a corresponding captured image in the test set until a test accuracy reaches a preset accuracy, thereby completing a model test of the machine learning model; solidifying a model architecture of the machine learning model that has passed the test to a to-be-compensated display device; writing model parameters of the machine learning model that has passed the test into the to-be-compensated display device; and processing to-be-compensated target grayscale data input into the to-be-compensated display device by using the machine learning model, and outputting applied grayscale data of the to-be-compensated display device based on the machine learning model.

Correspondingly, embodiments of the disclosure further provides a terminal, including a memory and one or more processors, where the memory stores a computer program executable by the one or more processors, and when executing the computer program, the one or more processor are configured to perform: providing a plurality of target grayscale data; acquiring a plurality of corresponding captured images based on the plurality of target grayscale data, where the captured images are divided into a training set and a test set; obtaining compensated result grayscale data of each captured image based on data calculation; providing a machine learning model; inputting target grayscale data and compensated result grayscale data of each captured image in the training set into the machine learning model for model training; after model training, inputting target grayscale data of each captured image in the test set into the trained machine learning model for model testing, and outputting corresponding predicted grayscale data based on the machine learning model; comparing each predicted grayscale data with compensated result grayscale data of a corresponding captured image in the test set until a test accuracy reaches a preset accuracy, thereby completing a model test of the machine learning model; solidifying a model architecture of the machine learning model that has passed the test to a to-be-compensated display device; writing model parameters of the machine learning model that has passed the test into the to-be-compensated display device; and processing to-be-compensated target grayscale data input into the to-be-compensated display device by using the machine learning model, and outputting applied grayscale data of the to-be-compensated display device based on the machine learning model.

Other aspects of the present disclosure may be understood by those skilled in the art in light of the description, the claims, and the drawings of the present disclosure.

### BRIEF DESCRIPTION OF THE DRAWINGS

In order to more thoroughly illustrate the technical solutions of the embodiments of the present disclosure, the drawings essential for understanding the embodiments will be briefly introduced hereinafter. Apparently, the drawings described below are merely some embodiments of the present disclosure. For a person skilled in the art, other drawings may be obtained based on these drawings without making creative efforts.

FIG. 1 is a schematic diagram showing a relationship between grayscale and brightness in AMOLED;

FIG. 2 is a schematic diagram showing a relationship between grayscale, brightness and chromaticity in MicroLED;

FIG. 3 is a flowchart of a machine learning-based display uniformity compensation method, according to some embodiments of the disclosure; and

FIG. 4 is a schematic diagram of a machine learning model in a machine learning-based display uniformity compensation method, according to some embodiments of the disclosure.

### DETAILED DESCRIPTION

In order to make the purposes, features and advantages of the disclosure more obvious and easy to understand, the technical solutions in the embodiments of the disclosure will be clearly and thoroughly described below in conjunction with the drawings in the embodiments of the disclosure. Apparently, the described embodiments are only part of the embodiments of the disclosure, not all of the embodiments. Based on the embodiments of the disclosure, all other embodiments obtained by a person skilled in the art without making creative efforts are within the scope of protection of the disclosure.

In the description of the disclosure, it should be noted that the terms “upper”, “lower”, “top surface”, “bottom surface” and the like indicate positions or positional relationships based on the positions or positional relationships shown in the drawings, and are merely for the convenience of describing the disclosure and simplifying the description, and do not indicate or imply that the positions or elements referred to must have a specific orientation, be constructed and operate in a specific orientation, and therefore cannot be understood as limitations of the disclosure. In addition, the terms “first” and “second” are used for descriptive purposes only, and cannot be understood as indicating or implying relative importance.

As described in the background section, there are still many problems in the existing technologies when MicroLED is compensated for display uniformity, which will be described in detail below with reference to the accompanying drawings.

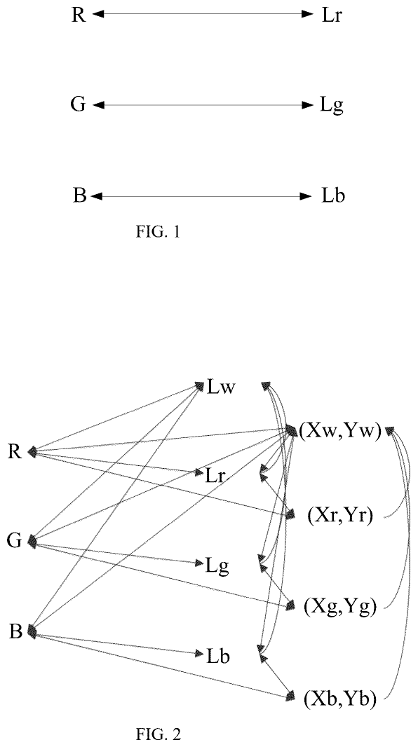

FIG. 1 is a schematic diagram showing a relationship between grayscale and brightness in AMOLED, and FIG. 2 is a schematic diagram showing a relationship between grayscale and brightness and chromaticity in MicroLED.

In AMOLED products, due to the high accuracy of color, when performing display uniformity compensation, it is usually sufficient to just compensate for the brightness of AMOLED products. Moreover, the grayscale (R, G, B) and brightness (Lr, Lg, Lb) of AMOLED products are in a one-to-one correspondence and do not interfere with each other (as shown in FIG. 1).

However, in MicroLED products, it is necessary to compensate for both the chromaticity and brightness of the MicroLED products. In addition, there is a many-to-many cross-correlation between the grayscale (R, G, B) and brightness (Lr, Lg, Lb) and chromaticity ((Xw, Yw), (Xr, Yr), (Xg, Yg), (Xb, Yb)) of the MicroLED products, which interfere with each other and make it difficult to find patterns in the data (as shown in FIG. 2).

The applicant has found that the reason for the above problems lies in that the luminous characteristics of MicroLED products are complex and there are too many influencing factors. This is mainly because the device efficiency and luminous wavelength of MicroLED will change with the variations in current density. The relevant change rule makes it very difficult to find and construct a functional relationship that may accurately describe it. Using an iterative approximation method results in a significant increase in computational load. The brightness and chromaticity of the MicroLED display screen vary greatly at different brightness levels, which also makes it impossible to use a set of compensation data to achieve full grayscale compensation, resulting in a surge in data storage and the inability to use a simple optical model to build compensation logic. If the traditional optical algorithm is used to calculate the results, the required amount of calculation and compensation will increase by more than 2 orders of magnitude compared to AMOLED products. If the compensation data is stored in the flash of the display module, and then the compensation data is called in real-time by the driver IC to compensate for the input display screen, it will put forward high requirements on the storage capacity of the flash and the computing power of the driver IC, which directly affects the feasibility of mass production.

The applicant has further identified that a machine learning algorithm is an algorithm that learns patterns and rules from data to make predictions and decisions. A machine learning algorithm may better fit nonlinear relationships, effectively process large-scale data, improve the scalability and efficiency of the algorithm, and better adapt to unobserved data, rather than just the ability to fit training data. Therefore, compensating for the display uniformity of MicroLED products based on machine learning may effectively improve the display uniformity compensation effect and efficiency.

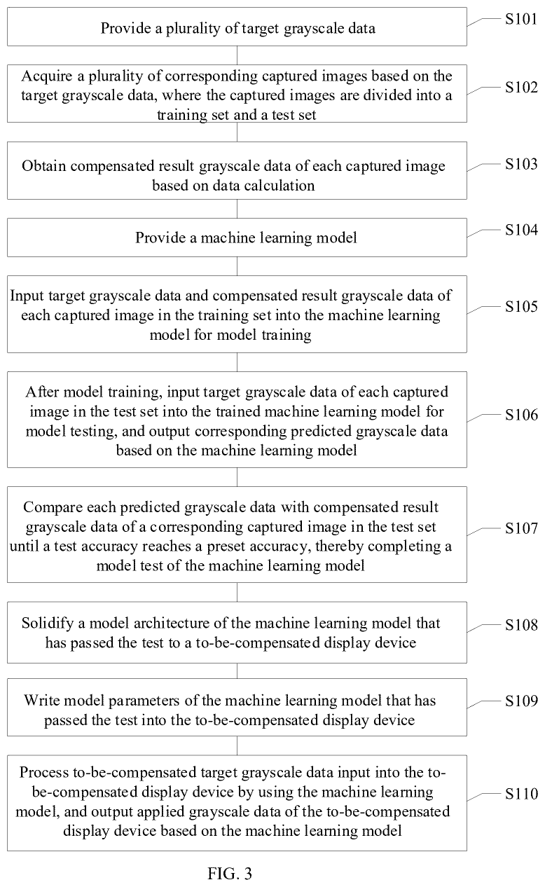

FIG. 3 is a flowchart of a machine learning-based display uniformity compensation method, according to some embodiments of the disclosure. The method includes the following.
Step S101: Provide a plurality of target grayscale data.
Step S102: Acquire a plurality of corresponding captured images based on the target grayscale data, where the captured images are divided into a training set and a test set.
Step S103: Obtain compensated result grayscale data of each captured image based on data calculation.
Step S104: Provide a machine learning model.
Step S105: Input target grayscale data and compensated result grayscale data of each captured image in the training set into the machine learning model for model training.
Step S106: After model training, input target grayscale data of each captured image in the test set into the trained machine learning model for model testing, and output corresponding predicted grayscale data based on the machine learning model.
Step S107: Compare each predicted grayscale data with compensated result grayscale data of a corresponding captured image in the test set until a test accuracy reaches a preset accuracy, thereby completing a model test of the machine learning model.
Step S108: Solidify a model architecture of the machine learning model that has passed the test to a to-be-compensated display device.
Step S109: Write model parameters of the machine learning model that has passed the test into the to-be-compensated display device.
Step S110: Process to-be-compensated target grayscale data input into the to-be-compensated display device by using the machine learning model, and output applied grayscale data of the to-be-compensated display device based on the machine learning model.

The steps of the machine learning-based display uniformity compensation method will be described in detail below with reference to the accompanying drawings.

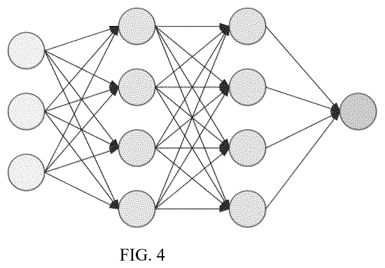

FIG. 4 is a schematic diagram of a machine learning model in the machine learning-based display uniformity compensation method, according to some embodiments of the disclosure.

In step S101, a plurality of target grayscale data are provided.

It should be noted that, in the disclosed embodiments, some of the target grayscale data may be input into a test display device through manual setting.

In step S102, a plurality of corresponding captured images are acquired based on the plurality of the target grayscale data, and the plurality of the captured images are divided into a training set and a test set.

In the disclosed embodiments, the method for obtaining the plurality of corresponding captured images based on the plurality of the target grayscale data includes: providing a test display device; inputting the plurality of the target grayscale data into the test display device, and displaying the plurality of corresponding display images based on the test display device; and using an image capture device to shoot each of the display images to obtain the corresponding captured images.

It should be noted that, in the disclosed embodiments, the target grayscale data does not include brightness data and chromaticity data, and the specific form of the target grayscale data is RxxxGxxxBxxx (where xxx is 000-255). The brightness data and chromaticity data of each pixel may be obtained merely by shooting a captured image.

In the disclosed embodiments, the number of captured images in the training set is greater than the number of captured images in the test set.

In step S103, compensated result grayscale data of each captured image is obtained based on data calculation.

In the disclosed embodiments, the method for obtaining the compensated result grayscale data of each captured image based on data calculation includes: extracting measured display data of each pixel on the captured image; providing target display data of each pixel on the captured image; obtaining a correlation function between target grayscale data and target display data of the captured image based on data fitting; adjusting the target grayscale data based on the correlation function to adjust the measured display data until the difference between the adjusted measured display data and the target display data meets a threshold, and using the adjusted target grayscale data as the compensated result grayscale data.

In the disclosed embodiments, the measured display data include measured brightness data and measured chromaticity data, and the target display data include target brightness data and target chromaticity data.

It should be noted that in the disclosed embodiments, when each pixel has no process deviation, that is, there is no need for display uniformity compensation, the target brightness data and the target chromaticity data may be calculated based on the input target grayscale data. That is, the target brightness data and the target chromaticity data are brightness data and chromaticity data under ideal conditions, and the data are known.

Data fitting is used to determine the specific compensation amount for the target grayscale data. For example, if the measured brightness data is found to be 10 nits higher than the target brightness data through shooting, the brightness difference here may be converted into grayscale data difference through data fitting to achieve compensation for the display data.

In a specific embodiment, if it is found that the measured brightness data of a certain pixel when displaying the target grayscale data as R160G000B000 is 10 nits higher than the target brightness data, through data fitting, it may be found that the target brightness data may be achieved by reducing the red color in the target grayscale data by 2 grayscales. The compensated target grayscale data then becomes R158G000B000, and R158G000B000 is the compensated result grayscale data. The compensated result grayscale data is known and correct data.

In step S104, a machine learning model is provided.

In the disclosed embodiments, the machine learning model includes a support vector machine model, a neural network model or a random forest model.

In the disclosed embodiments, a captured image is divided into several display areas, and the pixels on each display area display a same color, and the pixels on different display areas display different colors; or the color displayed by each pixel on the captured image is a random mixture. The colors displayed by each pixel on each captured image are kept as different as possible, so that the machine learning model has more comprehensive data support, thereby improving the accuracy of the applied grayscale data output by the machine learning model, and further improving the display uniformity compensation effect of the to-be-compensated display device.

In the disclosed embodiments, the ratio of the number of pixels showing a single red color on a captured image to the number of all pixels on the captured image is greater than 50%. Optionally, the ratio of the number of pixels showing a single red color on the captured image to the number of all pixels on the captured image is 70% or 80%.

Since micro-LEDs generally include red micro-LEDs, green micro-LEDs, and blue micro-LEDs, and the luminous efficiency of red micro-LEDs is lower than that of green micro-LEDs or blue micro-LEDs, the target grayscale data of red micro-LEDs corresponding to red colors differ or fluctuate greatly. Since the target grayscale data corresponding to the red color and the measured display data fluctuate greatly, in order to avoid large deviations of the captured data in the red color, it is necessary to set the ratio of the red color as large as possible so that the machine learning model may be fully trained using the data corresponding to the red color, thereby improving the accuracy of the machine learning model.

In the disclosed embodiments, the ratio of the number of pixels showing a single green color on a captured image to the number of all pixels on the captured image is less than 20%. Optionally, the ratio of the number of pixels showing a single green color on the captured image to the number of all pixels on the captured image is 10% or 5%. Since micro-LEDs generally include red micro-LEDs, green micro-LEDs and blue micro-LEDs, the luminous efficiency of green micro-LEDs is higher than that of red micro-LEDs, and the stability of the green color corresponding to the green micro-LEDs is better than that of the red color, and the volatility of the captured data for the green color is small. In order to collect more data for other colors, the ratio of the number of pixels showing a single green color to the number of all pixels on the captured image is less than 20%, so that the machine learning model may be fully trained using the data corresponding to other colors, thereby improving the accuracy of the machine learning model.

In the disclosed embodiments, the ratio of the number of pixels showing a single blue color on a captured image to the number of all pixels on the captured image is less than 20%. Optionally, the ratio of the number of pixels showing a single blue color on the captured image to the number of all pixels on the captured image is 10% or 5%. Since micro-LEDs generally include red micro-LEDs, green micro-LEDs and blue micro-LEDs, the luminous efficiency of blue micro-LEDs is higher than that of red micro-LEDs, and the stability of the blue color corresponding to the blue micro-LEDs is better than that of the red color, and the volatility of the captured data is small. In order to collect more data for other colors, the ratio of the number of pixels showing a single blue color to the number of all pixels on the captured image is less than 20%, so that the machine learning model may be fully trained using the data corresponding to other colors, thereby improving the accuracy of the machine learning model.

Optionally, the ratio of the number of pixels of a single red color to the number of all pixels on a captured image is 80%, the ratio of the number of pixels of a single blue color to the number of all pixels on the captured image is 10%, and the ratio of the number of pixels of a single blue color to the number of all pixels on the captured image is 10%.

In the disclosed embodiments, the ratio of the number of pixels displaying mixed colors on a captured image to the number of all pixels on the captured image is 10% to 30%. Optionally, the ratio of the number of pixels displaying mixed colors on the captured image to the number of all pixels on the captured image is 20%.

In step S105, target grayscale data and compensated result grayscale data of each captured image in the training set are input into the machine learning model for model training.

In the disclosed embodiments, during the model training stage, the target grayscale data of a captured image is taken as a condition, and the compensated result grayscale data of the captured image is taken as a result, and both are simultaneously input into the machine learning model, and the machine learning model learns and establishes a mapping relationship by itself.

In step S106, after model training, target grayscale data of each captured image in the test set is input into the trained machine learning model for model testing, and corresponding predicted grayscale data is output based on the machine learning model.

In the disclosed embodiments, during the model testing phase, only the target grayscale data of the captured image is input as a condition into the machine learning model, and the machine learning model learns and establishes a mapping relationship based on the training phase, and outputs the corresponding predicted grayscale data. However, whether the predicted grayscale data is accurate still needs to be verified based on the known and correct compensated result grayscale data.

In step S107, each predicted grayscale data is compared with the compensated result grayscale data of the corresponding captured image in the test set until the test accuracy reaches a preset accuracy, thereby completing the model test of the machine learning model.

In the disclosed embodiments, each predicted grayscale data is compared with the compensated result grayscale data of the corresponding captured image in the test set, and it is determined whether the predicted grayscale data passes the test based on an evaluation function.

In the disclosed embodiments, the method for determining whether the predicted grayscale data passes the test based on the evaluation function includes: inputting the predicted grayscale data and the corresponding compensated result grayscale data into the evaluation function to obtain an evaluation value; and when the evaluation value is within a preset evaluation threshold range, determining that the predicted grayscale data passes the test.

In the disclosed embodiments, the evaluation function includes: a Root Mean Square Error (RMSE) function and a goodness of fit function (R-squared, R2). The RMSE function and the goodness of fit function are used to measure the difference index between the predicted parameter value and the actual parameter value. When the difference index between the two is within the preset evaluation threshold range, it is considered that the two are matched.

For example, in a specific embodiment, if the output predicted grayscale data is R170G083B000, and the compensated result grayscale data is R170G085B000, although the two are not exactly the same, the evaluation value obtained by calculation based on the evaluation function is within the preset evaluation threshold range, then the predicted grayscale data is considered to have passed the test.

In the disclosed embodiments, the method of training until the test accuracy reaches the preset accuracy includes: when the test accuracy of the machine learning model does not reach the preset accuracy, increasing iterations of model training of the machine learning model until the test accuracy of the machine learning model reaches the preset accuracy.

In the disclosed embodiments, the method for increasing the iterations of model training of the machine learning model includes: inputting target grayscale data and compensated result grayscale data of a captured image in the test set that failed the test during the test into the machine learning model for model training.

In step S108, the model architecture of a machine learning model that has passed the test is solidified to a to-be-compensated display device.

In the disclosed embodiments, solidifying the model architecture into the to-be-compensated display device falls under the category of the hardware deployment of the algorithm. The general process is to first use the Field Programmable Gate Array (FPGA) platform to write the model architecture in the form of an algorithm, and perform functional simulation and verification. After the verification, the algorithm is converted into Register Transfer Level (RTL) or netlist and handed over to the chip manufacturer for design integration and finally tape-out.

In the disclosed embodiments, the test display device and the to-be-compensated display device are the same display device. Since the display effects of different display devices may be different, that is, the display uniformity compensation of each display device is different. Therefore, in order to avoid display differences between different display devices and achieve the best display uniformity compensation effect, the test display device and the to-be-compensated display device may be the same display device, that is, each to-be-compensated display device is debugged for display uniformity compensation before leaving the factory.

In other embodiments, if the process technology may ensure that the display differences of display devices of a same process batch are small enough, the test display device and the to-be-compensated display device may also be display devices of the same process batch, and only one or several display devices need to be debugged, and the debugging results may be applied to other display devices of the same process batch, thereby avoiding the step of debugging the display uniformity compensation for each to-be-compensated display device before leaving the factory, thereby improving production efficiency.

In step S109, the model parameters of the machine learning model that has passed the test are written into the to-be-compensated display device.

In the disclosed embodiments, the model parameters are solidified in the driver IC or Truck CONstructed (TCON) through One Time Programmable (OTP) or other data writing forms.

In step S110, the to-be-compensated target grayscale data input into the to-be-compensated display device is processed by the machine learning model, and applied grayscale data of the to-be-compensated display device is output based on the machine learning model.

The machine learning model is trained and tested through the target grayscale data and the compensated result grayscale data of a plurality of captured images. After the machine learning model passes the test, the applied grayscale data of the to-be-compensated display device may be quickly output based on the machine learning model, thereby effectively improving the display uniformity compensation effect and efficiency of the to-be-compensated display device. In addition, the model architecture and model parameters of the machine learning model that has passed the test are solidified to the to-be-compensated display device, which may effectively reduce or even completely eliminate the need to store compensation data, thereby greatly reducing the cost of data storage and drive calculations.

Correspondingly, embodiments of the disclosure further provide a non-transitory computer-readable storage medium, storing a computer program that, when being executed, causes at least one processor to implement the steps of any one of the above-mentioned embodiment methods.

Correspondingly, embodiments of the disclosure further provide a terminal, including a memory and one or more processors, where the memory stores a computer program executable by the one or more processors, and when executing the computer program, the one or more processor are configured to perform the steps of any one of the above-mentioned embodiment methods.

Compared with the existing technologies, the technical solutions of the disclosure have the following advantages: in the machine learning-based display uniformity compensation method, the machine learning model is trained and tested by the target grayscale data and the compensated result grayscale data of a plurality of captured images. After the machine learning model passes the test, the applied grayscale data of the to-be-compensated display device may be quickly output based on the machine learning model, thereby effectively improving the display uniformity compensation effect and efficiency of the to-be-compensated display device. In addition, the model architecture and model parameters of the machine learning model that has passed the test are solidified to the to-be-compensated display device, which may effectively reduce or even completely eliminate the need to store compensation data, thereby greatly reducing the cost of data storage and drive calculation.

Furthermore, the captured image is divided into a plurality of display areas, the pixels on each display area display the same color, and the pixels on different display areas display different colors; or the color displayed by each pixel on the captured image is a random mixture of colors. The colors displayed by each pixel on each captured image are kept different as much as possible, so that the machine learning model has more comprehensive data support, thereby improving the accuracy of the applied grayscale data output by the machine learning model, and further improving the display uniformity compensation effect of the to-be-compensated display device.

Furthermore, the ratio of the number of pixels showing a single red color on the captured image to the number of all pixels on the captured image is greater than 50%. Since the target grayscale data and the measured display data corresponding to the red color have relatively large regular fluctuations, it is necessary to set the ratio of red color as large as possible so that the machine learning model may be trained on more data corresponding to the red color, thereby improving the accuracy of the machine learning model.

Although the disclosure is described as above, the disclosure is not limited thereto. Any person skilled in the art may make various changes and modifications without departing from the spirit and scope of the disclosure. Therefore, the protection scope of the disclosure shall be subject to the scope defined by the claims.

What is claimed is:

1. A machine learning-based display uniformity compensation method, comprising:
providing a plurality of target grayscale data;
acquiring a plurality of corresponding captured images based on the plurality of target grayscale data, wherein the captured images are divided into a training set and a test set;
obtaining compensated result grayscale data of each captured image based on data calculation;
providing a machine learning model;
inputting target grayscale data and compensated result grayscale data of each captured image in the training set into the machine learning model for model training;
after model training, inputting target grayscale data of each captured image in the test set into the trained machine learning model for model testing, and outputting corresponding predicted grayscale data based on the machine learning model;
comparing each predicted grayscale data with compensated result grayscale data of a corresponding captured image in the test set until a test accuracy reaches a preset accuracy, thereby completing a model test of the machine learning model;
solidifying a model architecture of the machine learning model that has passed the test to a to-be-compensated display device;
writing model parameters of the machine learning model that has passed the test into the to-be-compensated display device; and
processing to-be-compensated target grayscale data input into the to-be-compensated display device by using the machine learning model, and outputting applied grayscale data of the to-be-compensated display device based on the machine learning model.

2. The method according to claim 1, wherein obtaining the plurality of corresponding captured images based on the plurality of the target grayscale data comprises:
providing a test display device;
inputting the plurality of the target grayscale data into the test display device, and displaying the plurality of corresponding display images based on the test display device; and
using an image capture device to shoot each of the display images to obtain the corresponding captured images.

3. The method according to claim 2, wherein the test display device and the to-be-compensated display device are a same display device, or are display devices of a same process batch.

4. The method according to claim 1, wherein obtaining the compensated result grayscale data of each of the captured images based on the data calculation comprises:
extracting measured display data of each pixel on the captured image;
providing target display data of each pixel on the captured image;
obtaining a correlation function between the target grayscale data and target display data of the captured image based on data fitting;
adjusting the target grayscale data based on the correlation function to adjust the measured display data until a difference between the adjusted measured display data and the target display data meets a threshold; and
using the adjusted target grayscale data as the compensated result grayscale data.

5. The method according to claim 4, wherein the measured display data include measured brightness data and measured chromaticity data, and the target display data includes target brightness data and target chromaticity data.

6. The method according to claim 1, wherein each predicted grayscale data is compared with compensated result grayscale data of a corresponding captured image in the test set, and whether the predicted grayscale data passes the test is determined based on an evaluation function.

7. The method according to claim 6, wherein determining whether the predicted grayscale data passes the test based on the evaluation function comprises:
inputting the predicted grayscale data and the corresponding compensated result grayscale data into the evaluation function to obtain an evaluation value; and
when the evaluation value is within a preset evaluation threshold range, determining that the predicted grayscale data passes the test.

8. The method according to claim 6, wherein the evaluation function includes one or more of a root mean square error function or a goodness of fit function.

9. The method according to claim 1, wherein training until the test accuracy reaches the preset accuracy comprises:
when the test accuracy of the machine learning model does not reach the preset accuracy, increasing iterations of model training of the machine learning model until the test accuracy of the machine learning model reaches the preset accuracy.

10. The method according to claim 9, wherein increasing the iterations of model training of the machine learning model comprises:
inputting target grayscale data and compensated result grayscale data of a captured image, in the test set, that failed the test during the test into the machine learning model for model training.

11. The method according to claim 1, wherein a number of captured images in the training set is greater than a number of captured images in the test set.

12. The method according to claim 1, wherein the machine learning model includes one or more of a support vector machine model, a neural network model or a random forest model.

13. The method according to claim 1, wherein the captured image is divided into a plurality of display areas, pixels on each of the display areas display a same color, and the pixels on different display areas display different colors.

14. The method according to claim 1, wherein a color displayed by each pixel on the captured image is a random mixture of colors.

15. The method according to claim 13, wherein a ratio of a number of pixels displaying a single red color on the captured image to a number of all pixels on the captured image is greater than 50%.

16. The method according to claim 13, wherein a ratio of a number of pixels displaying a single green color on the captured image to a number of all pixels on the captured image is less than 20%.

17. The method according to claim 13, wherein a ratio of a number of pixels displaying a single blue color on the captured image to a number of all pixels on the captured image is less than 20%.

18. The method according to claim 14, wherein a ratio of a number of pixels displaying mixed colors on the acquired screen to a number of all pixels on the acquired screen is 10%˜30%.

19. A non-transitory computer-readable storage medium, storing a computer program that, when being executed, causes at least one processor to implement a machine learning-based display uniformity compensation method comprising:
providing a plurality of target grayscale data;
acquiring a plurality of corresponding captured images based on the plurality of target grayscale data, wherein the captured images are divided into a training set and a test set;
obtaining compensated result grayscale data of each captured image based on data calculation;
providing a machine learning model;
inputting target grayscale data and compensated result grayscale data of each captured image in the training set into the machine learning model for model training;
after model training, inputting target grayscale data of each captured image in the test set into the trained machine learning model for model testing, and outputting corresponding predicted grayscale data based on the machine learning model;
comparing each predicted grayscale data with compensated result grayscale data of a corresponding captured image in the test set until a test accuracy reaches a preset accuracy, thereby completing a model test of the machine learning model;
solidifying a model architecture of the machine learning model that has passed the test to a to-be-compensated display device;
writing model parameters of the machine learning model that has passed the test into the to-be-compensated display device; and
processing to-be-compensated target grayscale data input into the to-be-compensated display device by using the machine learning model, and outputting applied grayscale data of the to-be-compensated display device based on the machine learning model.

20. A terminal, including a memory and one or more processors, wherein the memory stores a computer program executable by the one or more processors, and when executing the computer program, the one or more processor are configured to perform:
providing a plurality of target grayscale data;
acquiring a plurality of corresponding captured images based on the plurality of target grayscale data, wherein the captured images are divided into a training set and a test set;
obtaining compensated result grayscale data of each captured image based on data calculation;
providing a machine learning model;
inputting target grayscale data and compensated result grayscale data of each captured image in the training set into the machine learning model for model training;
after model training, inputting target grayscale data of each captured image in the test set into the trained machine learning model for model testing, and outputting corresponding predicted grayscale data based on the machine learning model;
comparing each predicted grayscale data with compensated result grayscale data of a corresponding captured image in the test set until a test accuracy reaches a preset accuracy, thereby completing a model test of the machine learning model;
solidifying a model architecture of the machine learning model that has passed the test to a to-be-compensated display device;
writing model parameters of the machine learning model that has passed the test into the to-be-compensated display device; and
processing to-be-compensated target grayscale data input into the to-be-compensated display device by using the machine learning model, and outputting applied grayscale data of the to-be-compensated display device based on the machine learning model.
